(19) United States
(12) Patent Application Publication
(10) Pub. No.: US 2026/0146005 A1
(43) Pub. Date: May 28, 2026

(54) INFILTRATION OF A FIBROUS STRUCTURE COMPRISING A LIQUID SILICON REACTIVE LAYER

(71) Applicant: SAFRAN CERAMICS, LE HAILLAN (FR)

(72) Inventors: Adrien DELCAMP, MOISSY-CRAMAYEL (FR); Jean-François HENNE, MOISSY-CRAMAYEL (FR); Benjamin COSSOU, MOISSY-CRAMAYEL (FR); Manon FERNANDEZ, MOISSY-CRAMAYEL (FR)

(21) Appl. No.: 19/121,595

(22) PCT Filed: Oct. 12, 2023
(86) PCT No.: PCT/FR2023/051591

§ 371 Date: Apr. 16, 2025

(30) Foreign Application Priority Data
Oct. 21, 2022 (FR) FR2210901

(51) Int. Cl. C04B 35/573; C04B 35/628; C04B 35/80

(52) U.S. Cl. CPC C04B 35/573; C04B 35/62863; C04B 35/62868; C04B 35/62873; C04B 35/62897; C04B 35/80; C04B 2235/5244; C04B 2235/5256; C04B 2235/616

(57) ABSTRACT

A process for manufacturing a part made of ceramic matrix composite material, the process including infiltrating a pre-densified fibrous structure with a molten infiltration composition including silicon, in order to form a ceramic matrix in a residual porosity of the pre-densified fibrous structure, the pre-densified fibrous structure including a pre-densification matrix including a first silicon carbide layer, a reactive layer including a reactive material that contains carbon and is capable of reacting with the silicon in the infiltration composition, the reactive layer covering the first layer, and a molten silicon wetting layer that is made of silicon carbide or carbon and covers the reactive layer.

### TECHNICAL FIELD

The invention relates to the manufacture of a part made of ceramic matrix composite material (CMC) during which the ceramic matrix is formed by infiltration of a silicon base composition in the molten state (“Melt-Infiltration”; “MI”). The composite material part obtained in this way can be used as a part of the hot portion of a turbomachine, in particular an aeronautical turbomachine, such as a turbine part.

### PRIOR ART

Ceramic matrix composite materials can withstand temperatures ranging from 600° C. to 1400° C. Due to their greater resistance to high temperatures, CMCs require less cooling. Since this cooling traditionally comes from a compressor bleed, which has an impact on the efficiency of the turbomachine, CMC materials can therefore improve engine efficiency, which in turn reduces fuel consumption. Furthermore, their use helps to optimise the performance of turbomachines, in particular by reducing the overall weight of the turbomachine, which in turn contributes to a reduction in fuel consumption and therefore to a significant reduction in polluting emissions.

CMC parts can be formed by melt infiltration. In this technique, a molten silicon composition can be introduced into the pores of a fibrous structure that is pre-densified by a silicon carbide deposit and filled with silicon carbide particles. This method produces a fully dense Si-SiC matrix with high modulus and a composite with a high linearity limit. The composites obtained have good mechanical properties, but the inventors have observed a certain variability in elongation at break, which reduces the damage tolerance zone of the material. It is desirable to propose a solution to overcome this disadvantage.

### Disclosure of the Invention

The invention aims precisely to respond to this need.

For this purpose, the invention proposes a method for manufacturing a part made of ceramic matrix composite material, said method comprising:
infiltrating a pre-densified fibrous structure with a molten infiltration composition comprising silicon, in order to form a ceramic matrix in a residual porosity of the pre-densified fibrous structure, said pre-densified fibrous structure comprising a pre-densification matrix comprising a first silicon carbide layer, a reactive layer comprising a reactive material that contains carbon and is capable of reacting with the silicon in the infiltration composition, the reactive layer covering the first layer, and a molten silicon wetting layer that is made of silicon carbide or carbon and covers the reactive layer.

In the application, the expression “wetting” should be understood in the usual sense of physical wetting between a surface and a liquid, the surface here being the surface of the wetting layer and the liquid the infiltrating composition. Wetting can be measured by the contact angle as it is usually defined, i.e. by the tangent to the liquid at the air/liquid/surface interface point. The smaller the contact angle, the better the wetting.

A layer is said to be “wetting” if the contact angle is less than 50°.

For example, the contact angle used to quantify wetting can be measured using a standing drop method, a hanging drop method using a goniometer, the Wilhelmy method or the capillary rise method.

In the process of the invention, the particular composition of the layers of the pre-densification matrix makes it possible to solve the technical problem.

This is because the liquid silicon first reacts with the molten silicon wetting layer, which it passes through to reach the reactive layer.

Once the reactive layer is reached, the liquid silicon reacts preferentially with this layer and therefore does not penetrate the first silicon carbide layer.

From the reactive layer, the flow of molten silicon is diverted away from the first layer and the underlying fibres, thus protecting the material.

Diverting the progression of the silicon ensures that the liquid silicon from the infiltration does not damage the pre-densified fibre structures in the way that it might do with the fibre structures of the prior art. The result is composite parts with properties that are less variable from one part to another.

In an embodiment, the reactive material may be selected from pyrolytic carbon or boron-doped carbon, for example boron-doped pyrolytic carbon.

These materials are preferred for the invention because they are easily deposited by chemical vapour infiltration processes. They are therefore good alternative reactive materials if the rest of the pre-densification of the fibrous structure is carried out by chemical vapour infiltration.

In an embodiment, the molten silicon wetting layer has a thickness greater than or equal to 0.2 μm, for example between 0.2 μm and 10.0 μm, or even between 1.0 μm and 10.0 μm.

In an embodiment, the molten silicon wetting layer has a columnar microstructure.

This embodiment can be obtained when the pre-densification of the fibrous structure is carried out by chemical vapour infiltration.

The columnar microstructure is then oriented with the grain boundaries along a direction transverse to a surface of the fibres. The columnar microstructure can limit the liquid silicon reaching the reactive material due to the need for infiltration between the columns, and therefore can offer good protection even with a thin layer of reactive material.

The reactive layer then redirects the direction of attack of the molten silicon, preventing it from continuing to propagate towards the fibres.

In an embodiment, the thickness of the reactive layer may be less than or equal to 1000 nm.

Having the smallest possible reactive layer ensures that the reactive layer does not affect the mechanical properties of the fibrous structure.

In an embodiment, the thickness of the reactive layer may be greater than or equal to 20 nm.

Having a sufficiently thick reactive layer ensures that the liquid silicon cannot pass through it during impregnation.

In an embodiment, the thickness of the reactive layer is between 20 nm and 1000 nm, or even between 200 nm and 500 nm.

This thickness of the reactive layer represents an optimum between the two effects described above.

In an embodiment, the ratio between the thickness of the molten silicon wetting layer and the thickness of the first layer of silicon carbide is between 40/60 and 10/90.

This ratio fixes the positioning of the reactive layer within the pre-densification matrix.

A ratio between the values proposed above can ensure that the thickness of the first silicon carbide layer is sufficient for the pre-densified fibrous structure to have the expected properties. The ratio also ensures that the reactive layer is sufficiently far from the outer surface of the pre-densification matrix (the surface furthest from the fibres) so that the molten silicon wetting layer prevents liquid silicon from reacting directly with the reactive layer, which is undesirable.

The invention has just been described with a single reactive layer.

In other embodiments, the pre-densification matrix can comprise, in addition to the molten silicon wetting layer, between one and eight additional protection structures, each additional structure comprising an additional reactive layer comprising a reactive material comprising a reactive material comprising carbon and capable of reacting with the silicon of the infiltration composition and an additional molten silicon wetting layer covering the additional reactive layer.

In the case where several additional protective structures are present, they can be placed in succession and in contact with one another.

The result is an alternation of reactive layers and molten silicon wetting layers, which ensures that, even in the case where the silicon crosses a reactive layer, it will be diverted to the next reactive layer.

In addition, an alternating structure in which there is more than one reactive layer allows the fibrous structure to better accommodate the heat generated by the chemical reaction between the silicon and one of the reactive layers.

The reaction between the silicon and the reactive layer can then take place over several reactive layers rather than just one, which ensures a better distribution of the heat produced, thus avoiding hot spots that can damage the integrity of the fibrous structure.

In an embodiment, the pre-densified fibrous structure further comprises an interphase of boron nitride between a fibrous reinforcement and the pre-densification matrix.

The presence of a boron nitride interphase advantageously deflects any cracks that may appear in the matrix of the composite part during operation, so as to preserve the fibre reinforcement.

In an embodiment, the fibrous structure comprises a pre-densified fibrous reinforcement formed by three-dimensional weaving or from a plurality of two-dimensional fibrous strata.

The particular choice of weave structure gives the pre-densified fibrous structure, and consequently the resulting part, particular mechanical properties.

Notably, such structures are most particularly suitable for parts used in the aeronautical industry.

In an exemplary embodiment, the part is a turbomachine part.

### BRIEF DESCRIPTION OF THE DRAWINGS.

FIG. 1 schematically shows a pre-densified structure that is usable for the invention.

FIG. 2 schematically shows the behaviour of molten silicon on a pre-densified structure during the process of the invention.

### DESCRIPTION OF THE EMBODIMENTS

The invention is now described by means of figures, having the descriptive aim of illustrating certain embodiments of the invention and which must not be interpreted as limiting the latter.

In addition, the figures are shown using non-realistic scales for ease of understanding, which should not be interpreted as the actual scales between the various elements.

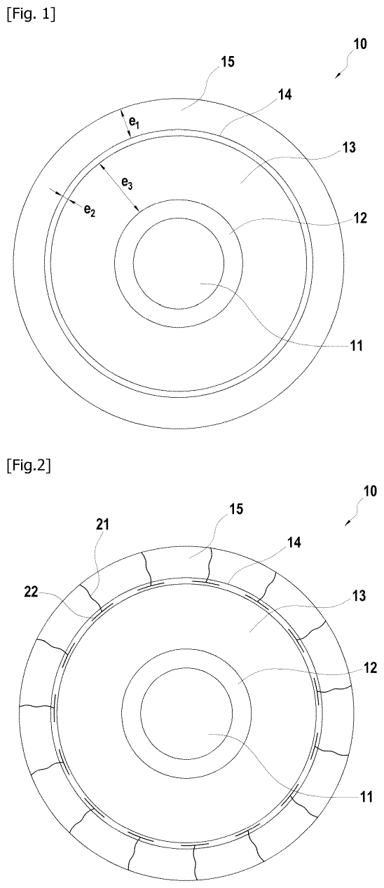

FIG. 1 shows a pre-densified fibrous structure that is usable for carrying out the process of the invention.

Such a pre-densified structure 10 may comprise a fibrous reinforcement 11, a boron nitride interphase 12, a first layer of silicon carbide 13, a reactive layer of a material comprising carbon 14 and a molten silicon wetting layer 15.

FIG. 1 is a projection in a plane perpendicular to the direction in which the longest direction of a fibrous reinforcement 11 of the structure 10 extends.

FIG. 1 also shows the thickness e1 of the molten silicon wetting layer 15, the thickness e2 of the reactive layer 14 and the thickness e3 of the first silicon carbide layer 13.

In an embodiment, the pre-densified fibrous structure comprises no elements other than the fibrous reinforcement 11 and the layers 12, 13, 14 and 15 just described.

In an embodiment, the interphase layer 12 is in contact with the fibre reinforcement 11, and in contact with the first silicon carbide layer 13.

In an embodiment, the first silicon carbide layer is in contact with the boron nitride interphase layer 12, and in contact with the reactive layer 14.

In an embodiment, the reactive layer 14 is in contact with the first silicon carbide layer 13, and in contact with the molten silicon wetting layer 15.

In an embodiment, the molten silicon wetting layer 15 is in contact with the reactive layer 14.

The fibrous structure can be formed by one or more textile operations, such as three-dimensional weaving. The fibrous structure may be formed from ceramic yarns, for example silicon carbide yarns.

In an embodiment, the fibrous reinforcements 11 of the pre-densified fibrous structure 10 can be formed of ceramic yarns, for example silicon carbide yarns. The fibrous structure can form the fibrous reinforcement of the composite material part to be obtained. Examples of silicon carbide yarns that can be used are yarns marketed under the references “Nicalon”, “Hi-Nicalon” or “Hi-Nicalon-S”. The ceramic yarns in the fibrous structure may have an oxygen content of 1% or less by atomic percentage. “Hi-Nicalon-S” yarns, for example, have such a property.

The term “three-dimensional weaving” or “3D weaving” should be understood as meaning a method of weaving by which at least some warp threads connect weft threads over a plurality of weft layers. A reversal of the roles between warp and weft is possible in the present description and should also be considered to be covered by the claims. The fibrous structure may have, for example, an interlock weave. The term “interlock weave or fabric”, should be understood to mean three-dimensional weaving, in which each layer of warp yarns connects a plurality of layers of weft yarns, with all the yarns of the same warp column having the same movement in the weave plane. It is also possible to start from fibrous textures such as two-dimensional fabrics or unidirectional sheets, and to obtain the fibrous structure by draping such fibrous textures on a form. These textures can optionally be bonded together, for example by stitching or implantation of yarns in order to form the fibrous structure.

In an embodiment, the interphase layer 12 can be formed by chemical vapour infiltration on the fibrous reinforcements 11 of the fibrous structure. The fibrous structure can be positioned in a shaping tooling enabling it to take the shape of the part to be obtained while the interphase is being deposited. The thickness of the interphase may be, for example, between 10 nm and 1000 nm, and for example between 10 nm and 100 nm. After formation of the interphase, the fibrous structure remains porous, the initially accessible porosity being filled only to a minority extent by the interphase. The interphase can be single-layered or multi-layered. The interphase may comprise at least one layer of pyrolytic carbon (PyC), boron nitride (BN), silicon-doped boron nitride (BN(Si), with the silicon having a proportion by mass of between 5% and 40%, the balance being boron nitride), or boron-doped carbon (BC, including boron in an atomic proportion between 5% and 20%, the balance being carbon). Here, the interphase has an embrittlement-release function for the composite material which promotes the diversion of possible cracks arriving at the interphase after having propagated in the matrix, preventing or delaying the breaking of the fibres by such cracks. Alternatively, it should be noted that it is possible to form the interphase on the yarns before the fibrous structure is formed. In an embodiment, pre-densification of the fibrous structure can be carried out by a chemical vapour infiltration process.

For example, the first silicon carbide layer 13 can be formed from a gas phase comprising methyltrichlorosilane (MTS) and hydrogen (H₂).

In an embodiment, the thickness e3 of the first layer of silicon carbide 13 can be between 0.2 μm and 10 μm.

For example, the first layer of silicon carbide 13 can be obtained in two successive chemical vapour infiltration phases.

For example, during a first phase, the fibrous structure is still positioned in the shaping tool and a first part of the first silicon carbide layer 13, known as the consolidation layer, is deposited on the interphase 12 and the fibre reinforcement 10. This consolidation layer can be deposited in contact with the interphase 12. This layer has sufficient thickness to sufficiently bind the fibres so that the structure retains its shape without assistance from the holding tool. This layer protects the interphase from oxidation and may be formed by chemical vapour infiltration in a manner known per se, for example from a gas phase comprising methyltrichlorosilane (MTS) and hydrogen (H₂). For example, the thickness of the consolidation layer may be greater than or equal to 0.1 μm, for example between 0.1 pm and 5.0 μm.

During the second phase, the consolidated fibrous structure shaped to the part to be obtained can be removed from the tooling and the pre-densification matrix can be formed by depositing a second portion of the first layer of silicon carbide 13 on the consolidation layer.

This first layer of silicon carbide makes a large contribution to the mechanical performance of the composite material and provides protection from the molten silicon used during subsequent infiltration.

In an embodiment, and according to the variant illustrated in FIG. 1, the consolidation layer may not be the subject of a specific deposit, and the first silicon carbide layer 13 of the pre-densification matrix could be formed directly on the interphase 12.

The formation of the first silicon carbide layer 13 may be followed by the deposition of a reactive layer 14.

The reactive layer 14 phase can be deposited by chemical vapour infiltration.

The chemical vapour infiltration can be carried out in the same reactor as the chemical vapour infiltration used to obtain the first layer of silicon carbide 13.

In particular, this reduces the number of movement operations of the fibrous reinforcement to be impregnated.

For example, the first layer of silicon carbide 13 can be deposited by a chemical vapour infiltration process. For example, a reactor is fed with silicon carbide precursors, the reactor being maintained at a temperature of between 950° C. and 1080° C. and at a pressure of between 10 and 40 mbar.

In order to switch from a deposition of silicon carbide 13 to deposition of a reactive layer 14, the supply of silicon carbide precursors is cut off, and reactive layer precursors are then introduced, optionally after purging the reactor.

The reactor pressure and temperature may or may not be modified.

For example, the reactive layer 14 can be formed from pyrolytic carbon.

This method avoids the use of boron in the process, except optionally for the interphase layer 12, which simplifies the chemical vapour infiltration process.

The reactive layer can be obtained from gaseous precursors chosen from hydrocarbons, in particular methane, propane or a mixture of these two compounds.

In an embodiment, the reactive layer can be doped with boron.

The boron in the reactive layer forms SiBₓ compounds to protect the underlying silicon carbide.

A BCl₃ precursor can be used to dope a boron-reactive layer 14 as described above. The reactive layer 14 deposited by a chemical vapour infiltration process produces a uniform layer on the fibrous reinforcements 11.

The thickness e2 of the reactive layer can be between 20 μm and 1000 μm.

As shown in FIG. 1, the reactive layer 14 can be covered with a molten silicon wetting layer 15.

For example, the molten silicon wetting layer 15 can be deposited by chemical vapour infiltration, for example under the same conditions as the first silicon carbide layer 13.

In an embodiment, in order to switch from depositing the reactive layer 14 to depositing the molten silicon wetting layer 15, the supply of reactive layer precursors is cut off, then silicon carbide precursors are introduced into the reactor, possibly after purging the reactor.

The reactor pressure and temperature may or may not be modified.

This makes it easy to switch from depositing the reactive layer 14 to depositing the molten silicon wetting layer 15.

The thickness e1 of the molten silicon wetting layer 15 may be between 0.2 μm and 10 μm.

FIG. 2 illustrates the importance of the reactive layer when infiltrating a fibrous structure.

Identical numerical references indicate identical elements between FIG. 1 and FIG. 2.

FIG. 2 shows the infiltration of liquid silicon 21 into the molten silicon wetting layer 15.

Infiltration 21 is shown very schematically in FIG. 2. However, it should be noted that the silicon has a progression in the molten silicon wetting layer 15 aligned with the direction transverse to the fibres. In addition, the attack on the liquid silicon can take place at several points on the outer surface of the fibre 10, as shown in FIG. 2.

However, the columnar structure of the molten silicon wetting layer 15 limits the access of liquid silicon 21 to the reactive layer 14.

The liquid silicon 22, which has nevertheless passed through the molten silicon wetting layer 15 and reaches the reactive layer 14, then changes direction on reacting with the reactive layer 14.

The reactive layer 14 hinders the progress of the liquid silicon towards the fibrous reinforcement 11 and ensures that the first silicon carbide layer 13, and above all the interphase 12 and the fibrous reinforcement 11, are protected from the liquid silicon 21, 22.

1. A process for manufacturing a ceramic matrix composite part, comprising:
infiltrating a pre-densified fibrous structure with a molten infiltration composition comprising silicon, in order to form a ceramic matrix in a residual porosity of the pre-densified fibrous structure, said pre-densified fibrous structure comprising a pre-densification matrix comprising a first silicon carbide layer, a reactive layer comprising a reactive material that contains carbon and is capable of reacting with the silicon in the infiltration composition, the reactive layer covering the first layer, and a molten silicon wetting layer that is made of silicon carbide and covers the reactive layer,
wherein the pre-densified fibrous structure comprises a fibrous reinforcement formed by three-dimensional weaving.

2. The process according to claim 1, wherein the reactive material is selected from pyrolytic carbon or boron-doped pyrolytic carbon.

3. The process according to claim 1, wherein the molten silicon wetting layer has a thickness of between 0.2 μm and 10.0 μm.

4. The process according to claim 3, wherein the molten silicon wetting layer has a columnar microstructure.

5. The process according to claim 1, wherein the thickness of the reactive layer is less than or equal to 1000 nm.

6. The process according to claim 1, wherein the ratio between the thickness of the molten silicon wetting layer and the thickness of the first layer of silicon carbide is between 40/60 and 10/90.

7. The process according to claim 1, wherein the pre-densification matrix can comprises, in addition to the molten silicon wetting layer, between one and eight additional protection structures, each additional structure comprising an additional reactive layer comprising a reactive material comprising carbon and capable of reacting with the silicon of the infiltration composition, and an additional molten silicon wetting layer made of silicon carbide or of carbon covering the additional reactive layer.

8. The process according to claim 1, wherein the pre-densified fibrous structure further comprises a boron nitride interphase, between a fibrous reinforcement and the pre-densification matrix

9. The process according to claim 1, wherein the part is a turbomachine part.
